(19) United States
(12) Patent Application Publication
(10) Pub. No.: US 2010/0236529 A1
(43) Pub. Date: Sep. 23, 2010

(54) FUEL INJECTION PUMP WITH AN IMPROVED DRIVE CLUTCH

(76) Inventors: Alfons Schoetz, Ditzingen (DE); Namik Karaosmanoglu, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/305,751

(22) PCT Filed: Jul. 5, 2007
(86) PCT No.: PCT/EP07/56827

§ 371 Date: Dec. 19, 2008

(30) Foreign Application Priority Data
Aug. 9, 2006 (DE) 10 2006 037 176.3

(51) Int. Cl. F02M 37/06; F02M 59/44

(52) U.S. Cl. 123/495

(57) ABSTRACT

The invention relates to a fuel injection pump for an internal combustion engine, which fuel injection pump, for the drive of the same, is connected in a torque-transmitting manner through a clutch unit to a drive input member. The clutch unit has a claw hub which is arranged on the drive input member and is axially fixed and is driven in rotation. The rotational movement can be transmitted to a reciprocating and rotating pump member. The claw hub and the pump member have respective claws which are aligned counter to one another and which have lateral claw faces between which is arranged a star-shaped and/or tongue-groove-like transmission body which, for the transmission of the torque, adjoins the respective claw faces. The claw faces are formed with an outwardly arched, spherical surface in order to create at least one defined zone of force introduction from the transmission body into the claw face, such that the stresses which occur in the claw as a result of the force transmission can be reduced. In this way, a fuel injection pump for an internal combustion engine with a clutch unit is created which permits a long service life while at the same time permitting the transmission of large torques, and at the same time has a simple structural design.

### PRIOR ART

The present invention relates to a fuel injection pump for an internal combustion engine, as recited in the preamble to claim 1.

Fuel injection pumps of the type that is of interest here are particularly used in internal combustion engines that use such fuel injection pumps to exert high pressure on the fuel to be injected, which is supplied to the internal combustion engine by means of fuel injectors.

The published, non-examined patent disclosure DE 41 05 353 A1 discloses a fuel injection pump of the type that defines the species, which has a clutch unit and is for an internal combustion engine, in which the recesses of the transmission component are embodied so that each respective recess simultaneously accommodates one claw each of the pump element and the claw hub situated next to each other and these claws engage in the recesses of the transmission component. This does in fact achieve the advantage that while occupying the same amount of space for the claws and for the transmission component, significantly higher drive torques can be transmitted from the claw hub to the pump element, but so-called edge loads can occur, which produce stress concentrations at the lateral edges of the claw surfaces, which can lead to a premature material fatigue and a failure of the clutch unit.

The published, non-examined patent disclosure DE 39 43 299 A1 discloses another fuel injection pump of the type that defines the species, which has a clutch unit and is for an internal combustion engine, in which lubrication openings are provided inside the claw surfaces to allow the outlet of lubricating oil and during operation, lubricating oil lubricates the claw surfaces. This does in fact make it possible to achieve an extension of the service life, but this extension of the service life is based solely on a reduced abrasive wear. Even with an optimized lubrication, it is not possible to significantly reduce a fatigue wear in the material of the claw hub and of the pump element or even in the transmission component as a result of powerful compressions that can arise due to the presence of edge loads.

The published, non-examined patent disclosure DE 195 41 606 A1 discloses a fuel injection pump, which has a clutch unit and is for an internal combustion engine, in which the transmission component is embodied in the form a cross disk and includes roller elements provided to produce a rolling support between the claw surfaces of the claw hub and the pump element. This arrangement does in fact increase the wear resistance of the contact surfaces between the claw hub and the pump element, but this construction also turns out to be very expensive because the roller elements must be supported in each of the respective struts of the cross disk.

The object of the present invention, therefore, is to produce a fuel injection pump for an internal combustion engine, which has a clutch unit that permits a long service life while simultaneously permitting the transmission of powerful torques and at the same time having a simple structural embodiment.

### DISCLOSURE OF THE INVENTION

This object is attained on the basis of a fuel injection pump for an internal combustion engine as recited in the preamble to claim 1, in combination with the defining characteristics of said claim. Advantageous modifications of the invention are disclosed in the dependent claims.

The invention includes the technical teaching that the claw surfaces are embodied with an outwardly curved, spherical surface in order to produce at least one definite zone of force introduction from the transmission component into the claw surface so that it is possible to reduce the stresses occurring in the claw due to the transmission of force. This results in the essential-to-the-invention advantage that through the introduction of spherical claw surfaces, the claws themselves and the cross disk are mainly stressed in a flexural fashion and the torsional stress is minimized. The geometry of the claws with correspondingly spherical claw surfaces achieves a stress reduction of up to 30%. In addition, the compression and therefore the wear between the claws and the transmission component are correspondingly reduced and improved since no edge loads occur. Edge loads are stress concentrations in boundary surfaces that can occur due to shape and position tolerances. These stress concentrations arise particularly at the throat between the claw and the body of the claw hub or pump element itself and can even lead to breakage of the claws. A spherical surface inside the claw surface achieves a definite force introduction so that the stress that occurs is introduced into the body of the claw in an optimal fashion, without the occurrence of stress concentrations, which can even cause the yield strength of the material to be reached.

Depending on the embodiment of the clutch unit, the transmission component can be embodied in the form of a cross disk so that the clutch unit is a cross-disk clutch. It is alternatively possible to embody the transmission component in the form of a spring plate so that the clutch unit is an Oldham clutch. In both clutch types, a transmission component is provided, which has either claws or spring elements that engage in grooves, which in turn are let into the claw hub and pump element. Even with a spring/groove connection, spherical regions can permit a stress introduction into the respective component surfaces, thus making it possible for the operating principle of avoiding edge loads to also be used with a spring/groove design.

According to another advantageous embodiment of the present invention, the outwardly curved, spherical surface of the claw surfaces corresponds to a section of a circumference surface of a cylinder so that a linear contact is produced between the claw surfaces and the transmission component. Alternatively, the outwardly curved, spherical surface of the claw surfaces can correspond to a section of a sphere so that a point contact is produced between the claw surfaces and the transmission component. With a linear contact between the claw surfaces and the transmission component, there is a higher load-carrying capacity than with a point contact, but a point contact has the advantage over a linear contact that shape and position tolerances can be compensated for in both the radial direction and the tangential direction. A grinding method is used to manufacture of the curved, spherical surface; it is also possible for the surfaces of the force introduction in the transmission component to likewise be spherically ground, provided that this is possible from a production engineering standpoint. The imaginary cylinder, whose circumference surface constitutes the outwardly curved, spherical surface of the claw surfaces, is oriented with its central axis orthogonal to the rotation axis of the claw hub and the pump element. This determines the direction in which the linear contact between the transmission component and the claw surfaces extends.

The spherical surface in the claw surfaces advantageously has a curvature radius R of 50 mm to 150 mm, preferably from 75 mm to 125 mm, and particularly preferably of 100 mm. The claw hub and the pump element of the pump unit each include two claws that extend in opposite directions oriented 180° apart from each other and constitute a respective claw pair. The claw pair of the claw hub and the claw pair of the pump element are offset from each other by 90° so that the transmission component fills the interstices that extend in the tangential direction between the claw pairs. The transmission component can be symmetrical so that the interstices between the claw pairs are likewise of equal dimensions.

According to another advantageous embodiment of the present invention, the claw hub and the pump element of the pump unit feature a steel material that includes the material 16MnCr5. The transmission component of the clutch unit is also advantageously composed of a steel material that includes the material 100Cr6. This steel material, which is generally known as a roller bearing material, has a high degree of purity and offers significant advantages in a material-removing machining.

The transmission component advantageously includes struts arranged in a star formation that are situated adjacent to the claw surfaces with a dimensional tolerance and the dimensional tolerance has a clearance of from 5 micrometers to 100 micrometers, preferably 25 micrometers to 75 micrometers, and particularly preferably 50 micrometers. This yields a slight clearance between the projections of the pump the transmission component, which are arranged in a star formation, and the respective claws so that no jamming or excessive compressions occur in the event of an offset between the central axes of the claw hub and the pump element and in the event of an angular offset.

According to another exemplary embodiment of the present invention, the claws have a throat at their transition into the base body of the claw hub and the pump element, with the outwardly curved, spherical surface of the claw surface extending the height of the claw, starting from the throat. The curvature of the claw surface extends with the curvature radius R to the outside of the claw, starting from the throat so that the linear contact is maintained even with an angular offset of the pump element in relation to the claw hub, only resulting in a shifting of the contact line between the claw and the support region of the transmission component.

Other measures that improve the invention, together with the description of the preferred exemplary embodiment of the invention, will be explained in greater detail below in conjunction with the drawings.

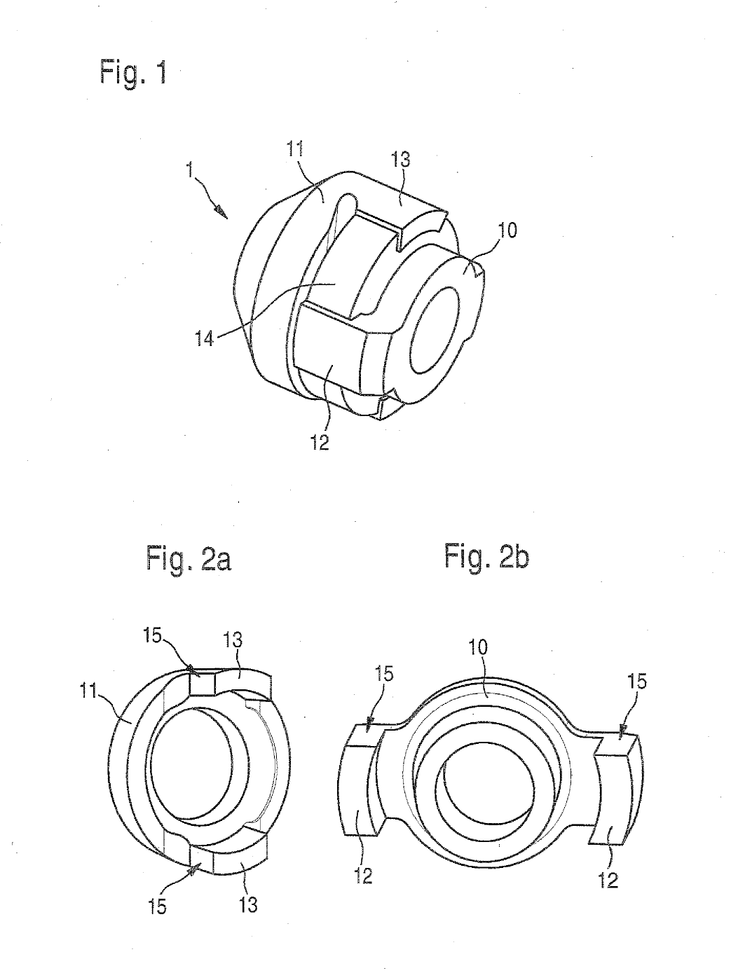

FIG. 1 is a perspective view of clutch unit of a fuel injection pump;

FIG. 2a is a perspective view of a pump element with a claw pair;

FIG. 2b is a perspective view of a claw hub with an associated claw pair;

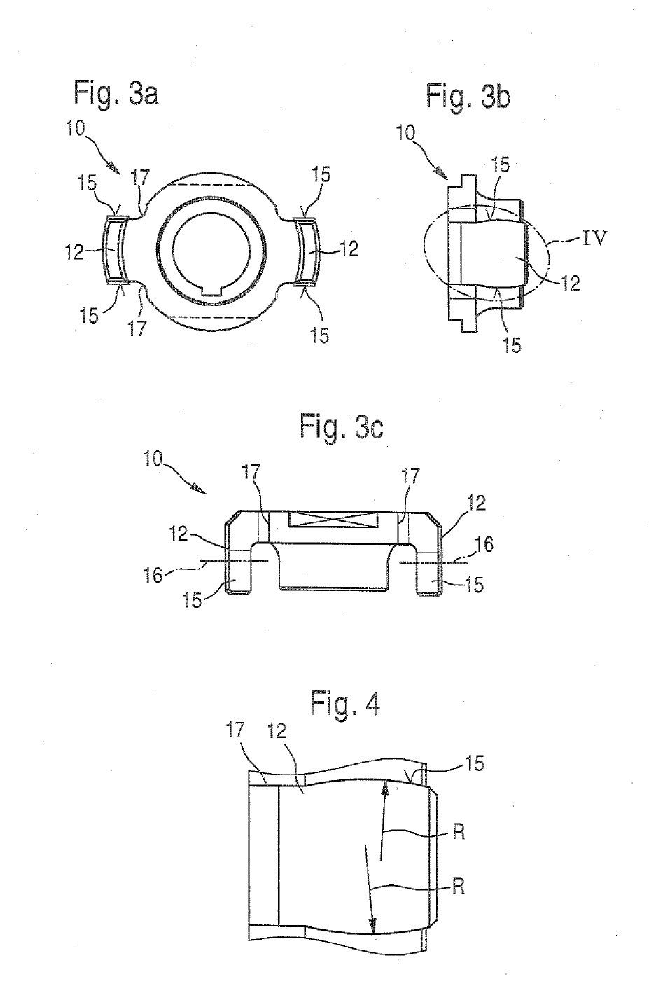

FIG. 3a is an isometric view of a claw hub with a claw pair formed onto it, in which the outwardly curved, spherical claw surfaces are visible;

FIG. 3b is another view of the claw hub from FIG. 3a;

FIG. 3e is another view of the claw hub from FIG. 3a and FIG. 3b; and

FIG. 4 shows a detail of a claw in an enlarged depiction of the claw hub according to FIG. 3b.

The clutch unit 1 shown in FIG. 1 is embodied in the form of a transmission component of the drive unit of a fuel injection pump for an internal combustion engine. The clutch unit 1 has a claw hub 10 into which a drive torque is introduced on the engine side. The rotary motion can be provided, for example, by the output side of the internal combustion engine. The claw hub 10 has a claw pair that is composed of two opposing claws 12. The claws 12 are formed onto the outside of the claw hub 10. In order to connect a rotating shaft of the drive unit to the claw hub 10, the base body of the claw hub 10 has a central opening into which the shaft of the drive unit can be inserted, which shaft is connected to the claw hub 10 in an axially and rotationally fixed fashion. On the opposite side from the claw hub 10, there is a pump element 11, which is functionally connected to the moving components of the fuel injection pump. The pump element 11 also has a claw pair composed of two claws 13 that extends toward the claw hub 10. The claws 12 and 13 constituting the respective claw pairs are situated opposite each other by 180°. The two claw pairs are in turn offset from each other by 90° so that in angular sections of 90° each, a claw 12 and a claw 13 follow each other in alternating fashion. Between the claws, there is a transmission component 14, which is embodied in the form of a cross disk in the present exemplary embodiment. The cross disk has four triangular segments that can be inserted in a precisely fitting fashion between the claws 12 and 13. A rotary motion introduced into the claw hub 10 can therefore be transmitted to the pump element 11 via the triangular segments of the transmission component 14. The rotation axis of the claw hub 10 and pump element 11 here can be spatially offset from each other and can even have an angular offset from each other, which can be compensated for by the arrangement of the claw hub 10, the pump element 11, and the transmission component 14.

FIGS. 2a and 2b, respectively, show a perspective detail view of the pump element 11 and a perspective detail view of the claw hub 10. The two claws 13 that are offset from each other by 180° are shown on the pump element 11. Each claw 13 has a first and second claw surface 15, which are constituted by the surface of the element and are adjacent to the transmission component, see FIG. 1. These claw surfaces 15 are situated on opposite sides from each other and laterally delimit the respective claw 12 and 13. Consequently, the clutch unit has a total of eight claw surfaces 15.

In order to more precisely depict the claws 12 with the respective embodiments of the claw surfaces 15, FIGS. 3a through 3c and FIG. 4 show the claw pair composed of the claws 12 in the example of the claw hub 10. The claw hub 10 is shown in an isometric fashion; it is depicted in a top view in FIG. 3a, a first side view in FIG. 3b, and a second side view in FIG. 3c. The claw surface 15 of the claws 12 is embodied as a respectively curved surface that laterally delimits the claw 12. This surface extends over the entire height of the claw 12 and extends from the outside of the claw to the base body of the claw hub 10. The linear contact 16 indicates the extension direction of the contact line between the claw surface 15 and the transmission element, which is not shown here. On the respective claw surfaces 15, these lines are oriented parallel to the center line of the claw hub 10. The claw surfaces 15 have a throat 17 at the transition to the base body of the claw hub 10 and the pump element 11; the claw surfaces 15 extend to the outside ends of the claws 12, 13, starting from the throat 17.

FIG. 4 shows the curvature radius R provided in the respective claw surface 15. FIG. 4 is a detail from FIG. 3b, which is labeled IV and is an enlarged depiction of the claw 12. This claw is delimited at the top and bottom by a respective claw surface 15, which has a curvature radius R that describes an outwardly curved, spherical surface of the claw surface 15, which curvature is not shown to scale for depiction-related reasons. The center point around which the curvature radius R is embodied is situated on the vertical dot-and-dash line in FIG. 4. The horizontal dot-and-dash line in FIG. 4, however, merely indicates the geometric center of the claw 12.

The embodiment of the invention is not limited to the preferred exemplary embodiment indicated above. Instead, there are a number of conceivable variants that make use of the embodiment depicted, even with fundamentally different embodiments.

1-10. (canceled)

11. A fuel injection pump for an internal combustion engine, which is connected in a torque-transmitting fashion by means of the clutch unit to a drive element in order to drive same; the clutch unit having
a rotary driven claw hub situated on the drive element in an axially fixed fashion,
a reciprocating and rotating pump element receiving rotary motion transmitted from the rotary driven claw hub; and
the claw hub and pump element each have opposing claws that include lateral claw surfaces between which a star-shaped and/or groove/spring-like transmission component is situated, the transmission component adjoining the respective claw surfaces for the purpose of transmitting torque, wherein the claw surfaces are embodied with an outwardly curved, spherical surface in order to produce at least one definite zone of force introduction from the transmission component into the claw surface, thus making it possible to reduce the stresses occurring in the claws due to the transmission of force.

12. The fuel injection pump as recited in claim 11, wherein the transmission component is embodied in the form of a cross disk so that the clutch unit is a cross-disk clutch.

13. The fuel injection pump as recited in claim 11, wherein the transmission component is embodied in the form of a spring plate so that the clutch unit is an Oldham clutch.

14. The fuel injection pump as recited in claim 11, wherein the outwardly curved, spherical surface of the claw surfaces corresponds to a section of a circumference surface of a cylinder so that a linear contact is produced between the claw surfaces and the transmission component.

15. The fuel injection pump as recited in claim 12, wherein the outwardly curved, spherical surface of the claw surfaces corresponds to a section of a circumference surface of a cylinder so that a linear contact is produced between the claw surfaces and the transmission component.

16. The fuel injection pump as recited in claim 13, wherein the outwardly curved, spherical surface of the claw surfaces corresponds to a section of a circumference surface of a cylinder so that a linear contact is produced between the claw surfaces and the transmission component.

17. The fuel injection pump as recited in claim 11, wherein the spherical surface in the claw surfaces has a curvature radius between 50 mm to 150 mm.

18. The fuel injection pump as recited in claim 11, wherein the spherical surface in the claw surfaces has a curvature radius between 75 mm to 125 mm.

19. The fuel injection pump as recited in claim 11, wherein the spherical surface in the claw surfaces has a curvature radius of 100 mm.

20. The fuel injection pump as recited in claim 11, wherein the claws each have a respective throat at a transition into a base bodies of the claw hub and the pump element, with the outwardly curved, spherical surface of the claw surface extending a height of the claw, starting from the throat.

21. The fuel injection pump as recited in claim 14, wherein the claws each have a respective throat at a transition into a base bodies of the claw hub and the pump element, with the outwardly curved, spherical surface of the claw surface extending a height of the claw, starting from the throat.

22. The fuel injection pump as recited in claim 11, wherein the claw hub and the pump element of the clutch unit each have two claws.

23. The fuel injection pump as recited in claim 14, wherein the claw hub and the pump element of the clutch unit each have two claws.

24. The fuel injection pump as recited in claim 21, wherein the claw hub and the pump element of the clutch unit each have two claws.

25. The fuel injection pump as recited in claim 11, wherein the claw hub and the pump element of the clutch unit are embodied by a steel material that includes the material 16MnCr5.

26. The fuel injection pump as recited in claim 24, wherein the claw hub and the pump element of the clutch unit are embodied by a steel material that includes the material 16MnCr5.

27. The fuel injection pump as recited in claim 11, wherein the transmission component of the clutch unit are embodied by a steel material that includes the material 100Cr6.

28. The fuel injection pump as recited in claim 26, wherein the transmission component of the clutch unit are embodied by a steel material that includes the material 100Cr6.

29. The fuel injection pump as recited in claim 11, wherein the transmission component includes struts arranged in a star formation that adjoin the claw surfaces with a dimensional tolerance that includes a clearance of from 5 micrometers to 100 micrometers.

30. The fuel injection pump as recited in claim 11, wherein the transmission component includes struts arranged in a star formation that adjoin the claw surfaces with a dimensional tolerance that includes a clearance of from 25 micrometers to 75 micrometers, and preferably of 50 micrometers.
